(19) United States
(12) Patent Application Publication
(10) Pub. No.: US 2023/0323595 A1
(43) Pub. Date: Oct. 12, 2023

(54) WATER-SOLUBLE FILM BASED DELIVERY SYSTEMS FOR COLORANTS, GLITTER, AND OTHER CHEMISTRIES

(71) Applicant: Crayola LLC, Easton, PA (US)

(72) Inventors: Michael G. Moskal, Pottstown, PA (US); Jacqueline Dyszel, Langhorne, PA (US); Morgan Tiziker, Ewing, NJ (US); Jane Patriarca, Hellertown, PA (US); Keith J. Allison, Blandon, PA (US)

(73) Assignee: Crayola LLC, Easton, PA (US)

(21) Appl. No.: 18/131,989

(22) Filed: Apr. 7, 2023

Related U.S. Application Data
(60) Provisional application No. 63/330,040, filed on Apr. 12, 2022.

(51) Int. Cl. D06P 5/00; D06P 1/52; D06P 1/00

(52) U.S. Cl. CPC D06P 5/001; D06P 1/5292; D06P 1/0096

(57) ABSTRACT

Casings, dye tablets, DIY activity-kits include one or more casings, one or more encased dye tablets, or a combination thereof, that are configured to impart an artistic effect to an article, hydrographic sheets, and dip and decorator activity-kits including one or more hydrographic sheets and an instruction for imparting an artistic effect to the article using the one or more hydrographic sheets. The casings include at least one compartment formed of a water-soluble film, and one or more agents disposed within the at least one compartment. The encased dye tablet includes one or more agents compounded with a filler and a binder. The one or more agents include at least one colorant formulation and at least one fixative.

### CROSS REFERENCE TO RELATED APPLICATIONS

This application claims priority from U.S. Provisional Patent Application No. 63/330,040, filed Apr. 12, 2022, the disclosure of which is incorporated herein by reference in its entirety for all purposes.

### FIELD OF THE INVENTION

The present invention relates to activity casings, encased dye tablets, hydrographic sheets, and DIY activity-kits including one or more activity casings, one or more encased dye tablets, or a combination thereof.

### BACKGROUND OF THE INVENTION

There are numerous do-it-yourself (DIY) coloring activity-kits, such as for finger paints, tie-dye, glitter-art, floating art for dip-art, available in the market. However, these commercially available DIY coloring activity-kits generally are quite messy and difficult to use and follow instructions for younger consumers, including use/release of some harsh chemicals, thereby requiring a practical limit on the suitable age for use (e.g., limiting the participation of younger consumers). There remains a need for DIY coloring activity-kits, which are low mess, easy to use, and with more accurate color placement.

### SUMMARY OF THE INVENTION

Disclosed herein is a casing comprising a) at least one compartment formed of a water-soluble film, and b) one or more agents disposed within the at least one compartment, wherein the one or more agents are configured to impart an artistic effect to an article.

In an embodiment of the casing, the one or more agents comprise one or more of a colorant formulation, a fixative, a water insoluble ink formulation, a multi-part leuco dye system, a multi-part effervescent composition, a multi-part silicone system, a multi-part chemiluminescent system, a glitter, and a fragrance.

In another embodiment, the casing comprises a single compartment formed of the water-soluble film, wherein the one or more agents comprises at least one colorant formulation and at least one fixative, disposed as a mixture in the compartment. In another embodiment, the casing comprises two or more compartments formed of the water-soluble film isolated from each other, and wherein the one or more agents comprises at least one colorant formulation and at least one fixative, wherein the colorant formulation and the fixative are disposed in separate compartments.

In an embodiment, the water-soluble film comprises one or more of poly(ethylene glycol) (PEG), polyvinyl pyrrolidone (PVP), polyvinyl alcohol (PVOH), polyvinyl acetate (PVA), polyacrylic acid (PAA), polyacrylamides, N-(2-hydroxypropyl) methacrylamide (HPMA), divinyl ether-maleic anhydride (DIVEMA), polyoxazoline, polyphosphates, and polyphosphazenes. In another embodiment, the water-soluble film comprises one or more of natural polymer films selected from the group consisting of xanthan gum, pectins, chitosan derivatives, dextran, carrageenan, guar gum, hyaluronic acid, albumin, and starch or starch-based derivatives.

In an embodiment, the colorant formulation comprises an acidic dye, a basic dye, a direct dye, a reactive dye, a sulfur dye, a fluorescent dye, a solvent dye, a food dye (FD&C), a cosmetic dye (D&C), a fabric dye, a polymeric dye, a fluorescent dye, a leuco dye, a photochromic dye, or a thermochromic dye. In another embodiment, the colorant formulation comprises a water-soluble dye selected from the group consisting of an acidic dye, a basic dye, a direct dye, a food dye (FD&C), a cosmetic dye (D&C), and a reactive dye.

In an embodiment of the casing, the one or more agents comprises an oxime silicone.

In another embodiment, the casing comprises at least two compartments, wherein the one or more agents comprises a multi-part formulation, and wherein each part of the multi-part formulation is disposed in a separate compartment of the at least two compartments. In yet another embodiment, the multi-part formulation comprises the multi-part leuco dye system, the multi-part silicone system, the multi-part chemiluminescent system, or the multi-part effervescent composition.

In an embodiment of the casing, the casing and each of the one or more compartments has a shape of a sphere, a hemisphere, a cylinder, a cube, a cuboid, an ellipsoid, a polyhedron, a star, a heart, or a toroid. In another embodiment, the casing is a compressible pouch, which when compressed ruptures the casing to release colorant formulation for creating an art form. In an embodiment, the water-soluble film has a thickness in the range of 10-150 μm.

In an aspect, the casing is an encased dye tablet, wherein at least one or more agents disposed within the at least one compartment is in a form of a dye tablet comprising one or more agents compounded with a binder and an optional filler, wherein one or more agents comprise at least one colorant formulation and at least one fixative and wherein the one or more agents are configured to impart an artistic effect to an article.

In an embodiment, the optional filler comprises a clay, a starch, a polymeric resin, or a saccharide. In another embodiment, the binder comprises hyaluronic acid powder, gelatin, gums, algininc acids and salts, and polymers.

In an embodiment, the colorant formulation comprises an acidic dye, a basic dye, a direct dye, a reactive dye, a sulfur dye, a fluorescent dye, a solvent dye, a food dye (FD&C), a cosmetic dye (D&C), a fabric dye, a polymeric dye, a fluorescent dye, a leuco dye, a photochromic dye, or a thermochromic dye. In another embodiment, the colorant formulation comprises a water-soluble dye selected from the group consisting of an acidic dye, a basic dye, a direct dye, a food dye (FD&C), a cosmetic dye (D&C), and a reactive dye.

In an embodiment of the encased dye tablet, the one or more agents further comprises a humectant, a preservative, a multi-part effervescent composition, a multi-part silicone system, a multi-part chemiluminescent system, a glitter, or a fragrance.

In an aspect, there is a DIY activity-kit comprising a) one or more casings as disclosed hereinabove, one or more encased dye tablets, or a combination thereof; and b) an instruction to form at least one of a decoration art, a tie-dye art, a glitter art, or a squeezable art, wherein the encased dye tablet comprises one or more agents compounded with a filler and a binder, wherein one or more agents comprise at least one colorant formulation and at least one fixative and wherein the one or more agents are configured to impart an artistic effect to an article.

In an embodiment of the DIY activity-kit, at least one of the one or more casings and one or more encased dye tablets comprises a colorant formulation and wherein the instruction to form a tie-dye art comprises the steps of:
a) contacting one or more casings, one or more dye tablets, or a combination thereof with a cloth article;
b) twisting and/or folding the cloth article about the one or more casings, one or more dye tablets, or a combination thereof;
c) binding the twists and folds of the cloth article to form a bound cloth article; and
d) contacting the bound cloth article with water to form a dyed cloth article.

In an embodiment, the DIY activity-kit, at least one of the one or more casings comprises one or more agents disposed within the at least one compartment of the one or more casings in a powdered form. In another embodiment, the at least one of the one or more casings comprises one or more agents disposed within the at least one compartment of the one or more casings in a form of the dye-tablet.

In an embodiment, the step of binding the twists and folds of the cloth article comprises securing the twists and folds of the cloth article using rubber bands or ties. In another embodiment, the instructions further comprise the step of removing the binding from the bound cloth article.

### BRIEF DESCRIPTION OF THE DRAWINGS

FIGS. 1A and 1B show different views of a compartment made of a water-soluble film of a casing according to an embodiment of the present invention.

FIGS. 2A and 2B show different views of a casing comprising one compartment and a colorant formulation disposed in the compartment according to an embodiment of the present invention.

FIG. 3 shows a cloth article tie-dyed using a DIY-activity-kit, according to embodiments of the present invention, the DIY-activity-kit comprising a plurality of casings, where each casing is filled with a different colorant formulation.

FIG. 4 shows a cloth article tie-dyed using a conventional DIY-activity-kit.

FIGS. 5A-5I shows a method of imparting artistic effect to an article using a hydrographic sheet compartment according to an embodiment of the present invention.

FIGS. 6A-6I show another exemplary method of imparting artistic effect to an article using a hydrographic sheet according to an embodiment of the present invention.

### DETAILED DESCRIPTION OF THE INVENTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

The present invention provides single-use activity casings, encased dye tablets, hydrographic sheets, and DIY activity-kits comprising one or more activity casings, encased dye tablets, or a combination thereof.

Casings

In an aspect, a casing comprises at least one compartment formed of a water-soluble film, and one or more agents disposed within the at least one compartment, wherein the one or more agents, alone or in combination, are configured to impart an artistic effect to an article.

Any suitable one or more agents may be used, including, but not limited to a colorant formulation, a fixative, a water insoluble ink formulation, a multi-part leuco dye system, a multi-part effervescent composition, a multi-part silicone system, a multi-part chemiluminescent system, a glitter, and a fragrance.

As used herein the phrase “imparting an artistic effect to an article” refers to transforming an article through the use of one or more agents, and does not include cleaning and/or bleaching the article.

As used herein, the term “artistic effect” refers to an effect that is preferably selected from the group consisting of color, scent, texture, glitter, pattern, and combinations thereof. Thus, when a dissolvable film imparts an artistic effect to an art material, the dissolvable film preferably imparts a color, a scent, a texture, glitter, a pattern, or a combination thereof to the art material. In preferred embodiments, the artistic effect is a coloring effect.

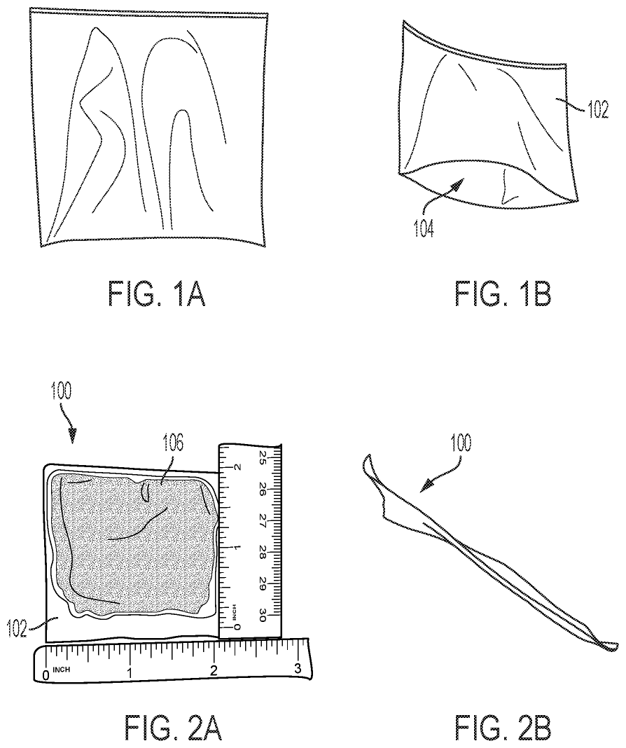

In an embodiment, the casing comprises a single compartment, made of a water-soluble film, as shown in FIGS. 1A and 1B, which show different views of the compartment of the casing. In an embodiment, the one or more agents comprises at least one colorant formulation and at least one fixative, disposed as a mixture in the compartment, as shown in FIGS. 2A and 2B, which show different views of a casing comprising one compartment and a colorant formulation disposed in the compartment. In another aspect, the one or more agents comprise at least one colorant formulation, such as fabric dyes that does not require a separate fixative.

In another embodiment, the casing comprises two or more compartments isolated from each other, and wherein the one or more agents comprises at least one colorant formulation and at least one fixative, wherein the colorant formulation and the fixative are disposed in separate compartments.

In an embodiment, the water-soluble film may include, but not limited to one or more of poly(ethylene glycol) (PEG), polyvinyl pyrrolidone (PVP), polyvinyl alcohol (PVOH), partially hydrolyzed polyvinyl acetate (PVA), polyacrylic acid (PAA), polyacrylamides, N-(2-hydroxypropyl) methacrylamide (HPMA), divinyl ether-maleic anhydride (DIVEMA), polyoxazoline, polyphosphates, and polyphosphazenes. In another embodiment of the casing, the water-soluble film comprises one or more of natural polymer films selected from the group consisting of xanthan gum, pectins, chitosan derivatives, dextran, carrageenan, guar gum, hyaluronic acid, albumin, and starch or starch-based derivatives. In an embodiment, the water-soluble film does not include a cellulose compound, including, but not limited to, methylcellulose, hydroxypropyl methylcellulose, ethylcellulose, and hydroxyethylcellulose.

In an embodiment, the one or more agents include a colorant formulation including, but not limited to an acidic dye, a basic dye, a direct dye, a reactive dye, a sulfur dye, a fluorescent dye, a solvent dye, a food dye (FD&C), a cosmetic dye (D&C), a fabric dye, a polymeric dye, a fluorescent dye, a leuco dye, a photochromic dye, or a thermochromic dye.

Acidic Dyes

The terms “acid dye” or “acidic dye” are recognized in the art and are intended to include those water-soluble anionic dyes that are applied to a material from neutral to acid solution. Attachment to the material is attributed, at least partly, to salt formation between anionic groups in the dyes and cationic groups in the material. Generally, acid dyes have functional groups such as azo, triaryl methane or anthraquinone that include acid substituents such as nitro, carboxy or sulfonic acid groups.

Representative examples of acid dyes useful in the present compositions include, but are not limited to, Acid Black 1, Acid Black 2, Acid Black 24, Acid Black 48, Acid Blue 1, Acid Blue 7, Acid Blue 9, Acid Blue 25, Acid Blue 29, Acid Blue 40, Acid Blue 45, Acid Blue 74, Acid Blue 80, Acid Blue 83, Acid Blue 90, Acid Blue 92, Acid Blue 113, Acid Blue 120, Acid Blue 129, Acid Blue 147, Acid Green 1, Acid Green 3, Acid Green 5, Acid Green 25, Acid Green 27, Acid Green 50, Acid Orange 6, Acid Orange 7, Acid Orange 8, Acid Orange 10, Acid Orange 12, Acid Orange 51, Acid Orange 51, Acid Orange 63, Acid Orange 74, Acid Red 1, Acid Red 4, Acid Red 8, Acid Red 14, Acid Red 17, Acid Red 18, Acid Red 26, Acid Red 27, Acid Red 29, Acid Red 37, Acid Red 44, Acid Red 50, Acid Red 51, Acid Red 52, Acid Red 66, Acid Red 73, Acid Red 87, Acid Red 88, Acid Red 91, Acid Red 92, v Acid Red 94, Acid Red 97, Acid Red 103, Acid Red 114, Acid Red 150, Acid Red 151, Acid Red 183, Acid Violet 7, Acid Violet 9, Acid Violet 17, Acid Violet 19, Acid Yellow 1, Acid Yellow 3, Acid Yellow 9, Acid Yellow 11, Acid Yellow 17, Acid Yellow 23, Acid Yellow 25, Acid Yellow 29, Acid Yellow 34, Acid Yellow 36, Acid Yellow 42, Acid Yellow 54, Acid Yellow 73, Acid Yellow 76 and Acid Yellow 99.

Basic Dyes

The terms “base dye” or “basic dye” are recognized in the art and are intended to include those water-soluble cationic dyes that are applied to a material from neutral to basic solution. Generally, basic dyes have functional groups such as sulfonium, oxonium, or quaternary ammonium functional groups. Attachment to the material is attributed, at least partly, to salt formation between cationic groups in the dyes and anionic groups in the material.

Representative examples of basic dyes useful in the present compositions include, but are not limited to, Basic Black 2, Basic Blue 3, Basic Blue 6, Basic Blue 7, Basic Blue 9, Basic Blue 11, Basic Blue 12, Basic Blue 16, Basic Blue 17, Basic Blue 24, Basic Blue 26, Basic Blue 41, Basic Blue 66, Basic Blue 140, Basic Brown 1, Basic Brown 4, Basic fuchsin, Basic Green 1, Basic Green 4, Basic Green 5, Basic Orange 2, Basic Orange 14, Basic Orange 21, Basic Red 1, Basic Red 2, Basic Red 5, Basic Red 9, Basic Red 29, Basic Violet 1, Basic Violet 2, Basic Violet 3, Basic Violet 4, Basic Violet 10, Basic Yellow 1, Basic Yellow 2, and Basic Yellow 49.

Direct Dyes

The term “direct dye” is recognized in the art and is intended to include those water-soluble dyes that adsorb onto a material. Bonding is believed to occur through hydrogen bonding and/or Van der Waals forces between the dye and the substrate.

Representative examples of direct dyes useful in the present compositions include, but are not limited to, Direct Blue 1, Direct Blue 14, Direct Blue 53, Direct Blue 71, Direct Red 2, Direct Red 23, Direct Red 28, Direct Red 75, Direct Red 80, Direct Red 81, Direct Violet 51, Direct Yellow 4, Direct Yellow 7, Direct Yellow 8, Direct Yellow 9, Direct Yellow 12, Direct Yellow 27, Direct Yellow 50, Direct Yellow 59, and Direct Yellow 62.

Reactive Dyes

The term “reactive dye” is recognized in the art and is intended to include those dyes that contain a reactive group, for example, either a haloheterocycle or an activated double bond, that, when applied to a surface in a weakly alkaline solution, forms a chemical bond with a hydroxyl or amino group on the substrate.

Representative examples of reactive dye compounds useful in the present compositions include, but are not limited to, Procion red, blue, orange and yellow (ICD), Levafix E Yellow (Bayer), Remazol Yellow (Hoechst), Cibacron (Ciba), Drimarene X, R, K (Sandoz), Scarlet MX-BRA, Yellow MX-3RA, Brilliant Yellow MX-8G, Green MX-700, Royal Blue MX-G1, Red MX-8B, Black MX-A, Purple MX-ADS, Violet MX BPS2, Orange MX-2R, Turquoise MX-G, Blue MX-R, Red BF-6BN, Golden Yellow BF-2GR, Blue HEGN, and Orange R3G, (all from Organic Dyes and Pigments), Reactive Black 5, Reactive Blue 2, Reactive Blue 4, Reactive Blue 13, Reactive Blue 109, Reactive Blue 140, Reactive Orange 4, Reactive Orange 16, Reactive Orange 86, Reactive Yellow 4, and Reactive Yellow 86.

Sulfur Dyes

The term “sulfur dye” is recognized in the art and is intended to include those dyes that contain sulfide linkages and are absorbed by a substrate and are insolubilised within or on the substrate by oxidation. During this process the sulfur dye forms complex larger molecules which are the basis of their good wash-fastness.

Representative examples of sulfur dyes useful in the present compositions include, but are not limited to, Sulfur Black 1 (Sulfur Black T) and Sulfur Blue (Patent Blue VF).

Fluorescent Dyes

The term “fluorescent dye” is recognized in the art and is intended to include those dyes which give fluorescence either in solid phase or in liquid form. The color of compound can be different from the fluorescence in liquid form.

Representative examples of fluorescent dyes/pigments useful in the present compositions include, but are not limited to, fluorescein, fluorescein diacetate, carboxyfluorescein, carboxyfluorescein diacetate, rhodamine B, sulforhodamine B, cotadecyl rhodamine B, rhodamine 6G, rhodamine 110, rhodaine 123, xanthene dyes, thioxanthene dyes, naphtholactam dyes, azlactone dyes, methane dyes, oxazine dyes, thiazine dyes, fluorol, coumarin, 7-N,N-dialkylamino-3-heteroarylcoumarin dyes, resorufin, quinoxalines, pyrido[1,2-a]benzimidazoles, acridine, acriflavin, acridine orange, nonyl acridine orange, xanthene, eosin Y, pyronine Y, Texas red, calcein, quinacrine, ethidium bromide, propidium iodide, resazurin, Nile Red or Nile Blue, crystal violet, DiO6(3), JC-1, YOYO-1, DAPI, Hoechst 33342, FM 1-43, thiazole orange, primuline, thioflavin T, calcein blue, morin, naphthol blue black, fura-2,4-amino-3-sulfo-1,8-naphthalimide, naphthalimide dyes, fluorescent pigments, and their derivatives.

Solvent Dyes

The term “solvent dye” is recognized in the art, with solubility in an organic solvent or solvents being a characteristic physical property of the solvent dye.

Representative examples of solvent dyes useful in the present compositions include, but are not limited to, Solvent Black 3, Solvent Black 5, Solvent Blue 14, Solvent Blue 35, Solvent Blue 38, Solvent Blue 43, Solvent Blue 59, Solvent Brown 1, Solvent Green 1, Solvent Green 3, Solvent Green 7, Solvent Green 11, Solvent Orange 1, Solvent Orange 2, Solvent Orange 7, Solvent Orange 15, Solvent Red 19, Solvent Red 23, Solvent Red 24, Solvent Red 26, Solvent Red 27, Solvent Red 41, Solvent Red 43, Solvent Red 45, Solvent Red 49, Solvent Red 72, Solvent Violet 8, Solvent Yellow 2, Solvent Yellow 3, Solvent Yellow 7, Solvent Yellow 14, Solvent Yellow 33, Solvent Yellow 94, manufactured by Sigma-Aldrich, St. Louis, MO; and Special Fluorescent Yellow 3G (Solvent Green 7), manufactured by Lanxess Corporation, Pittsburgh, PA.

“FD&C” and “D&C” Dyes

The terms “FD&C” and “D&C” dyes are recognized in the art. In the United States, colorants for food, drugs and cosmetics are regarded as “color additives”. The Federal Food, Drug & Cosmetic (FD&C) Act of 1938 made food color additive certification mandatory. Since then the Food and Drug Administration (FDA) has been responsible for regulating all color additives used in food, drugs and cosmetics. Each batch to be sold in the United States has to be certified by the FDA. To avoid confusing color additives used in food with those manufactured for other uses, 3 categories of certifiable color additives were created: 1) FD&C (Food, Drug & Cosmetics) color additives with applications in food, drug & cosmetics 2) D&C (Drug & Cosmetics) color additives with applications in drug & cosmetics 3) External D&C (External Drug & Cosmetics) color additives with applications in externally applied drugs & in externally applied cosmetics. The use of all food colors approved for use in the United States are listed in 21 CFR (Code of Federal Regulation), parts 70 through 82 dealing with color additives.

Representative examples of FD&C dyes useful in compositions of the invention include, but are not limited to FD&C Blue 1, FD&C Blue 2, FD&C Green 3, FD&C Red 3, FD&C Red 40, FD&C Yellow 5, FD&C Yellow 6, Fast Emerald Green, and mixtures thereof, manufactured by Sensient Colors Inc., St. Louis, Mo., Vitasyn Tetrazine X 90, Vitasyn Orange RGL 90, Vitasyn Quinoline Yellow 70, Vitasyn Ponceau 4RC 82, Vitasyn Blue AE 90, Vitasyn Patent Blue V 85 01, Sanolin Flavin 8GZ, Sanolin Yellow BG, Sanolin Red NBG, Sanolin Rhodamine B, Sanolin Violet E2R, Sanolin Violet FBL, Sanolin Blue NBL, Sanolin Blue EHRL, Sanolin Blue EHRL Liquid, and mixtures thereof, manufactured by Clariant Corp., Coventry, RI.

Polymeric Colorants

The term “polymeric colorant” is recognized in the art and polymeric colorants are a group of intermediate or high molar mass compounds that are intrinsically colored. Polymeric dyes may be defined through their applications as polymers and dyes, which possess suitably high tinctorial strength. Polymeric dyes are characterized by having polymeric chains covalently bonded to a chromophore (dye) molecule.

Representative examples of polymeric dyes useful in compositions of the invention include, but are not limited to, Palmer Orange B 113, Palmer Blue B232, Palmer Magenta, Palmer Fluorescent Red, Palmer Yellow R, Palmer Scarlett, Palmer Black B57, Palmer Patent Blue, LiquiTone Magenta 418, Polytint Violet X80LT, Polytint Orange X96, Polytint Yellow X15, Polytint Black X41LV, Polytint Red X64, Polytint Blue X3LV, & mixtures thereof, manufactured by Milliken & Co., Spartanburg, SC

Photochromic Dyes

Some leuco dyes used for thermochromism, as disclosed herein, also exhibit photochromism. Other photochromic materials include spiropyrans and in particular, benzospiropyran photochromic dyes. Suitable benzospiropyran photochromic colorants include, but are not limited to 6-nitro-8-methoxy-1′,3′,3′-trimethylspiro[2H-1-benzopyran-2,2′-indoline]; 6-nitro-8-methoxy-5′-chloro-1′,3′,3′-trimethylspiro[2H-1-benzopyran-2,2′-indoline]; 6-nitro-8-methoxy-5-bromo-1′,3′,3′-trimethylspiro[2H-1-benzopyran-2,2′-indoline]; 6-nitro-8-methoxy-5-bromo-5′-chloro-1′,3′,3′-trimethylspiro[2H-1-benzopyran-2,2′-indoline]; 6,5′-dinitro-8-methoxy-1′,3′,3′-trimethylspiro[2H-1-benzopyran-2,2′-indoline]; 6-nitro-8-ethoxy-1′,3′,3′-trimethylspiro[2H-1-benzopyran-2,2′-indoline].

Other spiropyrans useful in the invention are derivatives of the following classes of compounds: spiro[2H-1-benzopyran-2,2′-[1H]-benzo[g]indoline]; spiro[2H-benzopyran-2,2′[1H]-benzo[e]indoline]; spiro[indoline-2,3′[3H]-naphtho[2,1-b]pyran]; spiro[2H-1-benzopyran-2,2′-benzothiazolines]; spiro[benzothiazoline-2,3′[3H]-naphtho[2,1-b]pyran]; 2,2′-spirobi[2H-1-benzopyran]; 3,3-spirobi[3H-naphtho[2,1-b]pyran]; 2,2′-spirobi[2H-naphtho[1,2-b]pyran]; spiro[2H-1-benzopyran-2,3′[3H]-naphtho[2,1-b]pyran]; spiro[2H-1-benzopyran-2,2′-[2H]-naphtho[1,2-b]pyran]; spiro[4H-1-benzopyran-4,3′[3H]naphtho[2,1-b]pyran]; spiro[2H-naphtho[1,2-b]pyran-2,3′[3H]-naphtho[2,1-b]pyran]; spiro[indoline-2,2′-pyrano[3,2-H]quinoline]; spiro[2H-1-benzopyran-2,2′[2H]quinoline].

Other Photochromic Dyes

Other classes of photochromic dyes include: triarylmethane dyes, cationic polymethane dyes, indenone oxides, nitrones, bis-imidizoles, hexaarylethanes, β-tetrachloroketodihydronaphthalenes, hydrazines, nitroso-dimers, aryl disulfides, stilbenes, indigoids, azo compounds, polyenes, cyanine dyes, unsaturated azines, p-phenyl ketones, nitropyridenes, nitrophenylmethanes, p-nitrobenzyl compounds, dihydroxyanthenones, bianthrones, trans-15,16-dialkyldihydropyrenes, 2H-pyrans, 2H-thiopyrans, and cis-1-aryl-2-nitroalkenes.

Specific photochromic coating formulations are known in the art. See, for example, U.S. Pat. Nos. 4,367,170, 8,801,976, and 9,777,178, all of which are expressly incorporated herein by reference. Photochromic dyes are commercially available from LCR Hallcrest and Chromatic Technologies Inc.

Thermochromic Dyes

Suitable thermochromic dyes include, but are not limited to spirolactones, fluorans, spiropyrans, and fulgides. More specifically, thermochromic dyes are based on diphenylmethane phthalide derivatives, phenylindolylphthalide derivatives, indolylphthalide derivatives, diphenylmethane azaphthalide derivatives, phenylindolylazaphthalide derivatives, fluoran derivatives, styrylquinoline derivatives, and diazarhodamine lactone derivatives. These include: 3,3-bis(p-dimethylaminophenyl)-6-dimethylaminophthalide; 3-(4-diethylaminophenyl)-3-(1-ethyl-2-methylindol-3-yl)phthalide; 3,3-bis(1-n-butyl-2-methylindol-3-yl)phthalide; 3,3-bis(2-ethoxy-4-diethylaminophenyl)-4-azaphthalide; 3-[2-ethoxy-4-(N-ethylanilino)phenyl]-3-(1-ethyl-2-methylindol-3-yl)-4-azaphthalide; 3,6-dimethoxyfluoran; 3,6-di-n-butoxyfluoran; 2-methyl-6-(N-ethyl-N-p-tolylamino)fluoran; 3-chloro-6-cyclohexylaminofluoran; 2-methyl-6-cyclohexylaminofluoran; 2-(2-chloroanilino)-6-di-n-butylaminofluoran; 2-(3-trifluoromethylanilino)-6-diethylaminofluoran; 2-(N-methylanilino)-6-(N-ethyl-N-p-tolylamino)fluoran, 1,3-dimethyl-6-diethylaminofluoran; 2-chloro-3-methyl-6-diethylaminofluoran; 2-anilino-3-methyl-6-diethylaminofluoran; 2-anilino-3-methyl-6-di-n-butylaminofluoran; 2-xylidino-3-methyl-6-diethylaminofluoran; 1,2-benzo-6-diethylaminofluoran; 1,2-benzo-6-(N-ethyl-N-isobutylamino)fluoran, 1,2-benzo-6-(N-ethyl-N-isoamylamino)fluoran; 2-(3-methoxy-4-dodecyloxystyryl)quinoline; spiro[5H-(1)benzopyrano(2,3-d)pyrimidine-5,1′(3′H)isobenzofuran]-3′-one; 2-(diethylamino)-8-(diethylamino)-4-methyl-spiro[5H-(1)benzopyrano(2,3-d)pyrimidine-5,1′(3′H)isobenzofuran]-3′-one; 2-(di-n-butylamino)-8-(di-n-butylamino)-4-methyl-spiro[5H-(1)benzopyrano(2,3-d)pyrimidine-5,1′(3′H)isobenzofuran]-3′-one; 2-(di-n-butylamino)-8-(diethylamino)-4-methyl-spiro[5H-(1)benzopyrano(2,3-d)pyrimidine-5,1′(3′H)isobenzofuran]-3′-one; 2-(di-n-butylamino)-8(N-ethyl-N-isoamylamino)-4-methyl-spiro[5H-(1)benzopyrano(2,3-d)pyrimidine-5,1′(3′H)isobenzofuran]-3′-one; and 2-(di-n-butylamino)-8-(di-n-butylamino)-4-phenyl and trisubstituted pyridines.

Leuco Dye

Examples of suitable leuco dyes include, but are not limited to, diarylphthalide dyes, fluoran dyes, indolyphthalide dyes, acylleucoazine dyes, leucoauramine dyes, spiropyrane dyes, rhodaminelactam dyes, triarylmethane dyes and chromene dyes. Preferred leuco dyes include, but are not limited to, 9′-(diethylamino)spiro[2-benzofuran-3,12′-benzo[a]xanthene]-1-one (Red DCF), 6′-(dibutylamino)-3′-methyl-2′-(phenylamino)-3H-spiro[isobenzofuran-1,9′-xanthen]-3-one (such as Specialty Black 34), a substituted phthalide such as Specialty Grape 7, 2-di(phenylmethylamino-6′-(diethylamino)spiro(isobenzofuran-1(3H),9′-(9H)-xanthen))-3-one (Green DCF), and proprietary dyes such as Specialty Yellow 37 and Specialty Cyan 39. Products identified under the Specialty tradename are commercially available from DyStar LP, Charlotte, NC.

Fixatives

Suitable fixatives include but are not limited to soda ash (sodium carbonate), sodium bicarbonate, sodium chloride, sodium sulfate, sodium silicate, sodium acetate, potassium carbonate and ammonium sulfate. Any commercial non-aqueous fixative may also be used.

In an embodiment, the colorant formulation comprises a water-soluble dye selected from the group consisting of an acidic dye, a basic dye, a direct dye, a food dye (FD&C), a cosmetic dye (D&C), and a reactive dye.

In another embodiment, the one or more agents comprises the water-insoluble ink formulation for creating dip art.

In an aspect, the casing comprises at least two compartments, wherein the one or more agents comprises a multi-part formulation, and wherein each part of the multi-part formulation is disposed in a separate compartment of the at least two compartments. Any suitable multi-part formulation may be used, including, but not limited to the multi-part leuco dye system, a multi-part silicone system as disclosed hereinbelow, the multi-part chemiluminescent system, or the multi-part effervescent composition.

Multi-Part Leuco Dye System

In an embodiment, the multi-part leuco dye system comprises a two-part leuco dye system. The leuco dye system comprises a color precursor/colorant, which is a leuco dye, as disclosed hereinabove, and a color change-inducing compound/developer, which may be a Lewis acid. The Lewis acid causes a rearrangement of the leuco dye molecule, which results in the development of a chromophore of intense color. Suitable Lewis acids include, but are not limited to, zinc-containing resins, certain clays, or phenolic resins.

Multi-Part Silicone System

In an embodiment, the multi-part silicone system comprises a two-part catalyst-cured silicone system comprising a first silicone polymer, a second silicone polymer and a catalyst. In an embodiment the first and the second silicone polymers are disposed in two separate compartments of the casing. In another embodiment, the catalyst is included in either of the two compartments, with either the first silicone polymer or the second silicone polymer. In yet another embodiment, the catalyst is evenly divided between the two compartments.

The multi-part silicone system of the present invention employs components which, when combined, will cure at room temperature (i.e., without additional heating) within 30 seconds to 60 minutes or within 1 to 30 minutes or 5 to 20 minutes.

As used herein, the term “cured composition” refers to a composition comprising a silicon copolymer-based resin which is a catalyst mediated crosslinking reaction product, and may also comprise residual catalyst and one or more additives.

The two-part silicone system of the present invention requires the “squeeze” method. Since the silicones are not water-soluble, they could be combined by squeezing the contents of two separate casings or a single two-compartment casing. One of the advantages of the two-part silicone system of the present invention is that the two reactive components could be metered in exact proportions in the two separate casings or a single two-compartment casing.

First Silicone Polymer

In an embodiment, the first silicone polymer comprises poly(organosiloxane-co-hydroorganosiloxane). In another embodiment, the first silicone polymer has at least one hydrogen atom bonded to silicon. Suitable examples of the first silicone polymer include, but are not limited to, hydride-terminated methylhydrosiloxane-dimethylsiloxane copolymers, trimethylsiloxyterminated methylhydrosiloxane-dimethylsiloxane copolymers, hydride-terminated polydimethylsiloxanes, trimethylsiloxy-terminated polymethylhydrosiloxanes, hydride-terminated polyphenylmethylsiloxane, hydride-terminated polyphenyl(dimethylhydrosiloxy)siloxane, hydride-terminated methylhydrosiloxane-phenylmethylsiloxane copolymer and mixtures thereof.

Second Silicone Polymer

In another embodiment, the second silicone polymer comprises an alkenyl-functional organopolysiloxane. In an embodiment, the alkenyl-functional organopolysiloxane is an alkenyl-terminated organopolysiloxane, where the alkenyl group is at least present on the terminal silicon atom of the organopolysiloxane. In another embodiment, the alkenyl-functional organopolysiloxane is not an alkenyl-terminated organopolysiloxane, but one where the alkenyl group is present along the silicon backbone of the organopolysiloxane. Suitable examples of alkenyl-functional organopolysiloxane include, but are not limited to, vinyl-terminated polydimethylsiloxane, vinyl-terminated diphenylsiloxane-dimethylsiloxane copolymers, vinyl-terminated polyphenylmethylsiloxane, vinyl-terminated diethylsiloxane-dimethylsiloxane copolymers, trimethylsiloxy-terminated vinylmethylsiloxane-dimethylsiloxane copolymers, vinyl-terminated vinylmethylsiloxane-dimethylsiloxane copolymers, vinylmethylsiloxane homopolymers, hydride-terminated vinylmethylsiloxane-dimethylsiloxane copolymers, vinylmethylsiloxane-phenylmethylsiloxane copolymers, vinylmethylsiloxane homopolymers, and mixtures thereof.

Catalyst

As used herein, the term “cure” refers to a catalyst mediated cross-linking reaction between the first silicone polymer and the second silicone polymer. In one embodiment, curing involves a platinum (or other precious metal catalyst) mediated crosslinking reaction between a poly(organosiloxane-co-hydroorganosiloxane) and an alkenyl-functional organopolysiloxane.

Any suitable heterogeneous or homogeneous catalyst can be used, including, but not limited to, platinum, palladium, iridium, and rhodium. In an embodiment, the catalyst is platinum. In another embodiment, the catalyst can be present as a complex with a ligand that can function not only as a diluent, but also as a cure retarder/moderator or an inhibitor to slow down the curing process giving the user time to mix the contents of a first and a second compartment of a casing, i.e. time to mix a first silicone polymer, a second silicone polymer, and a catalyst to form a mixture and before the mixture hardens. The catalyst may be present in at least one of the two compartments comprising at least one of the first silicone polymer and the second silicone polymer, in any suitable amount, such as, from about 0.001 wt % to about 6 wt %, or about 0.01 wt % to about 4 wt %, or about 0.1 wt % to about 1.0 wt %, based on the total weight of the cured composition. In an embodiment, the catalyst may be present in a second compartment comprising the second silicone polymer, and optionally the diluent. In another embodiment, the catalyst may be present in a first compartment comprising the first silicone polymer. In yet another embodiment, the catalyst may be present in a third compartment comprising a complex of catalyst with a ligand and an excess ligand that can function as a diluent or moderator. In an embodiment, the first, the second, and the third compartments are all present on the same casing. In another embodiment, the first, the second, and the third compartments are present in at least two different casings in any suitable combination.

Multi-Part Chemiluminescent System

The use of chemiluminescent, or oxyluminescent, reactions to produce light without the use of electricity, is known. These reactions involve chemical components which react chemically and provide excitation of a fluorescent compound. In an embodiment, a multi-part chemiluminescent system comprises oxalates, fluorescing dyes, and oxidizers. For example, one known chemistry involved in the production of visible light through chemiluminescent reactions is based on the reaction of a hydroperoxide and a chemiluminescent reactant comprised of an oxalate, such as an oxalic-type anhydride, an oxalic-type ester, or an oxalic-type amide, and a fluorescer.

Suitable examples of the oxidizers/oxygen-providing compound include, but are not limited to common chemical bleaches such as sodium hypochlorite, chlorine bleach, and oxygen bleach, which contains hydrogen peroxide, and a perborate, such as sodium perborate.

An exemplary multi-part yellow chemiluminescent system may comprise an “oxalate” component and an “activator” component. The oxalate component may include dipropylene glycol dibenzoate as the solvent, bis(2,4,5-trichloro-6-carbopentoxyphenyl)oxalate as the oxalate, and 1-chloro-9,10-bis(phenylethynyl)anthracene as the fluorescer. The activator component is the oxidizing composition and may include triethyl citrate, t-butyl alcohol, hydrogen peroxide, and sodium salicylate.

Multi-Part Effervescent Composition

Multi-part effervescent compositions generally include an agent that is capable of releasing carbon dioxide (CO₂) (for example, sodium carbonate and sodium bicarbonate) and an agent that induces releases of CO₂ (for example, adipic acid, malic acid, tartaric acid, ascorbic acid, fumaric acid, maleic acid, succinic acid, or citric acid). These agents react rapidly in the presence of water to release carbon dioxide. Multi-part effervescent compositions may include these agents along with binders, diluents, and lubricants.

The casing of the present invention and each of the one or more compartments may have any suitable shape, including but not limited to a shape of a sphere, a hemisphere, a cylinder, a cube, a cuboid, an ellipsoid, a polyhedron, a star, a heart, or a toroid. In an embodiment, the shape and size of each of the one or more compartments are the same. In another embodiment, at least one of the one or more compartments differ in shape and/or size from the other compartments. The water-soluble film forming the casing and the compartment may have any suitable thickness depending upon the desired use, as the rate of dissolution of the water-soluble film depends upon its thickness. In an embodiment, the water water-soluble film has a thickness in the range of at least 10 μm, 15 μm, 18 μm, 20 μm, 25 μm, 27 μm, 30 μm, or 50 μm and equal to less than 30 μm, 50 μm, 80 μm, 90 μm, 100 μm, 125 μm, or 150 μm. In an embodiment, the water water-soluble film has a thickness in the range of 10-150 μm, or 25-150 μm, or 27-90 μm, or 30-85 μm, or 30-50 μm, or 50-80 μm.

In an aspect, the casing is a squeezable pouch which when compressed ruptures the casing to release a colorant formulation for creating an art form. In an embodiment, at least one squeezable pouch is placed between two pieces of paper and compressed to create art form on the two pieces of paper.

The one or more agents disposed within the at least one compartment of the casing may be in any suitable form, such as powder, liquid, gel, solid form such as a tablet.

Encased Dye Tablet

In one aspect, the casing is an encased tablet, where at least one or more agents disposed within the at least one compartment of the casing is in a form of a dye tablet. The encased dye tablet includes one or more agents, as disclosed hereinabove, compounded with a binder and an optional filler, to form a dye-tablet, wherein the one or more agents are configured to impart an artistic effect to an article. The one or more agents may comprise at least one colorant formulation, as disclosed hereinabove, and at least one fixative, as disclosed hereinabove. In an embodiment of the encased dye tablet, the at least one colorant formulation comprises a reactive dye, as disclosed hereinabove. In another embodiment, the reactive dye comprises Scarlet MX-BRA, Yellow MX-3RA, Brilliant Yellow MX-8G, Green MX-700, Royal Blue MX-G1, Red MX-8B, Black MX-A, Purple MX-ADS, Violet MX BPS2, Orange MX-2R, Turquoise MX-G, Blue MX-R, Red BF-6BN, Golden Yellow BF-2GR, or mixtures thereof.

The encased dye tablet of the present invention and each of the one or more compartments of the casing, including a dye tablet, may have any suitable shape, including but not limited to a shape of a sphere, a hemisphere, a cylinder, a cube, a cuboid, an ellipsoid, a polyhedron, a star, a heart, or a toroid.

In an embodiment, the dye tablet may comprise a total amount of colorant formulation(s) in the range of 1 to 12%, or 3 to 10%), or 5 to 8%, by mass, based on the total mass of the dye tablet.

The filler may be present in an amount of in the range of 5 to 50%), or 10 to 35%, or 20 to 25%, by mass based on the total mass of the dye tablet. Any suitable filler may be used, including, but not limited to a clay, a starch, a polymeric resin, and saccharides. Exemplary clays include, but are not limited to talc, kaolin, montmorillonite, and bentonite. Exemplary starches include, but are not limited to corn starch, potato starch, rice starch, wood flour, wheat starch, arrowroot starch, tapioca flour, or wheat flour.

The binder may be present in an amount of in the range of 10 to 50%, or 12 to 40%, or 15 to 30%, by mass based on the total mass of the dye tablet. Any suitable binder may be used, including but not limited to gelatin, gums, algininc acids and salts, and polymers. The binder may comprise hyaluronic acid powder, polyethylene glycol, polyvinyl pyrrolidone, polyvinyl alcohol, gelatin, guar gum, xanthin gum, and sodium alginate.

DIY Activity-Kit

In an aspect, there is a DIY activity-kit comprising a one or more casings, one or more encased dye tablets, or a combination thereof, as disclosed hereinabove and one or more instructions to form at least one of a decoration art, a tie-dye art, a dip art, a glitter art, or a squeezable art.

In an embodiment of the DIY activity-kit, each of the one or more casings and the encased dye tablets comprises a colorant formulation. The colorant formulation of each of the one or more casings and the encased dye tablets can be the same or different. The instruction to form a dyed art comprises the steps of:
a) contacting one or more casings, one or more encased dye tablets, or a combination thereof with a cloth article;
b) twisting and/or folding the cloth article about the one or more casings to dispose the one or more casings, one or more encased dye tablets, or a combination thereof on the folds of the cloth article or within the folds of the cloth article;
c) binding the twists and folds of the cloth article to form a bound cloth article to secure the one or more casings, encased dye tablets, or a combination thereof to the cloth article; and
d) contacting the bound cloth article with water for any suitable amount of time, such as for example for 6-12 hours or 6-15 hours or 6-18 hours to form a dyed cloth article.

In an embodiment, the step of binding the twists and folds of the cloth article comprises securing the twists and folds of the cloth article using rubber bands or ties. In another embodiment, the instructions further comprise the step of removing the binding from the bound cloth article.

In an embodiment, the step of contacting the bound cloth article with water comprises placing the bound cloth article in a leak-proof container along with water to reduce mess. Any suitable leak-proof container can be used, including, but not limited to a plastic bag, a plastic Ziplock bag, a silicone bag, a silicone Ziplock bag, a plastic box, and a snap-seal plastic container.

In another embodiment of the DIY activity-kit, the casings comprise the water insoluble ink formulation and wherein the instruction to form a dip art comprises placing one or more casings comprising the water-insoluble ink formulation in water, whereby the water-soluble film dissolves, thereby leaving the water insoluble ink floating on the water and followed by dipping and removing an article from the water to form a dipped-art article.

Additional aspects of the present invention include, but are not limited to the following:

In an aspect, the one or more agents comprise fragrance encapsulated in a casing to modify the product.

In an aspect, the casing encapsulates an effervescent tab, where a multi-part effervescent system is disposed in two separate compartments of the effervescent tab. In another embodiments, each part of the multi-part effervescent system is disposed a separate casing with one compartment. The effervescent tabs in contact with a liquid paint result in a textured paint.

In an aspect, the casing comprises encapsulated pigments for changing the color of finger paints by physical means instead of thermochromically.

The casings, the hydrographic sheets, and the DIY kits as disclosed hereinabove provide several advantages over the current commercial products, including, but not limited to being low mess (tie-dye process in plastic bag as containment system), increased color intensity compared to current commercial products, minimal skin contact with dyes/fixatives, and compact design with minimal packaging needed. Additionally, the casings and the DIY activity-kits are eco-friendly as there are no disposable containers for colorant formulations. Instead the colorant formulations are disposed in water-soluble casings.

Dip and Decorator Hydrographic Sheet

In another aspect, a hydrographic sheet is provided. The hydrographic sheet is formed of a partially or a fully water-soluble film, having decoration art formed from a non-aqueous ink or dye disposed on at least one side of the sheet, wherein the hydrographic sheet leaves floating art upon dissolution in water, and wherein the floating decoration art comprises a softened and at least partially solubilized water-soluble film with decoration art for adhering to an article.

Any suitable fully water-soluble film disclosed hereinabove maybe used. The water-soluble film may comprise one or more of natural polymer films as disclosed hereinabove. The article may be composed of any suitable material including, but not limited to a cloth, a plastic, a metal, or a human skin.

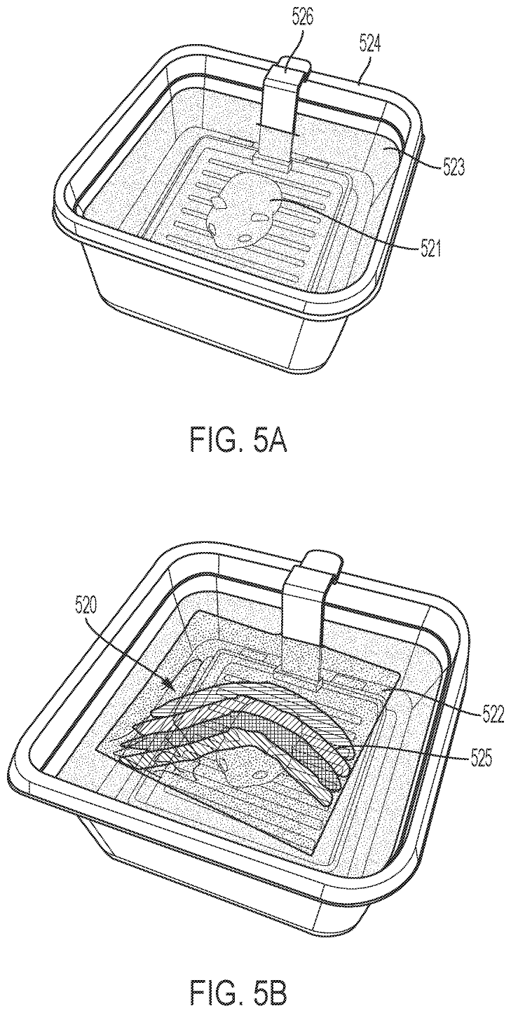

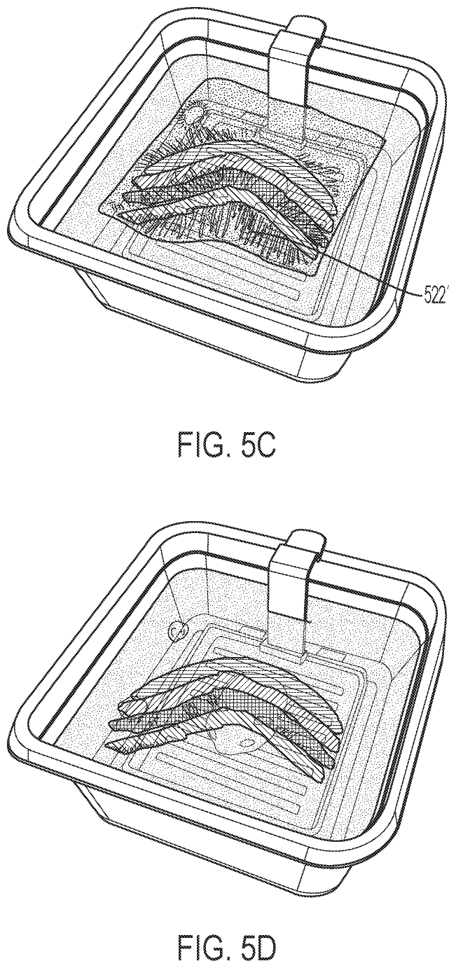

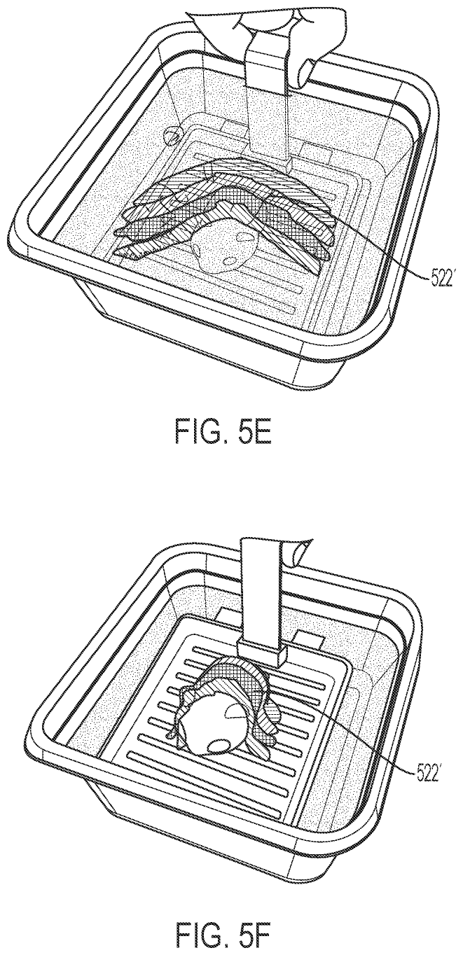

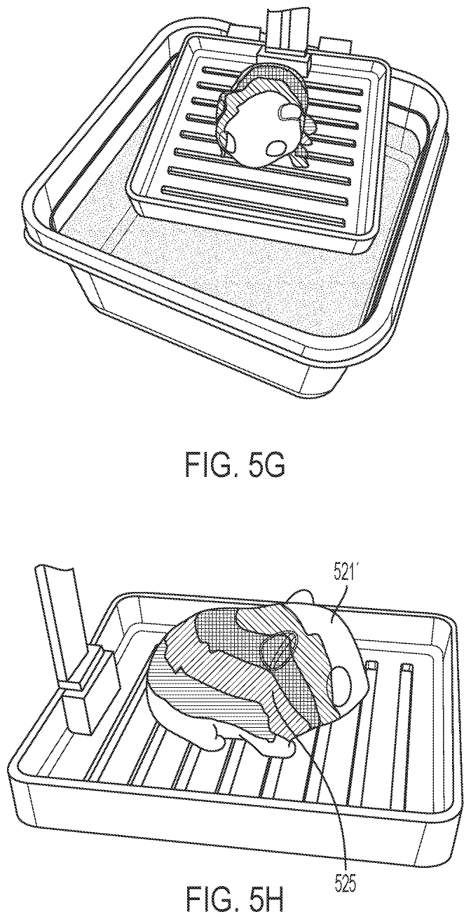

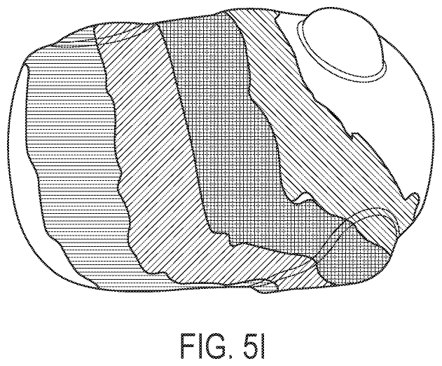

FIGS. 5A-5I show a method of using a hydrographic sheet for imparting decoration art onto an article, such as a toy plastic mouse. FIG. 5A shows an article being placed in warm water. The water can be kept at any suitable temperature for example in the range of 20 to 60° C., or 25 to 50° C., or 30 to 40° C. FIG. 5B shows a hydrographic sheet being placed on the surface of the water. FIG. 5C shows portions of the hydrographic sheet being expanded due to water absorption. Once a surface of the hydrographic sheet on the surface of the water smooths out, as shown in FIG. 5D, one can lift the article, a toy plastic mouse, out of the water, as shown in FIG. 5E, such that the article is surrounded by the hydrographic sheet, as shown in FIG. 5F, and followed by drying as shown in FIGS. 5G and 5H. Once completely dry, as shown in FIG. 51, the article has a film with decoration art adhered onto the article.

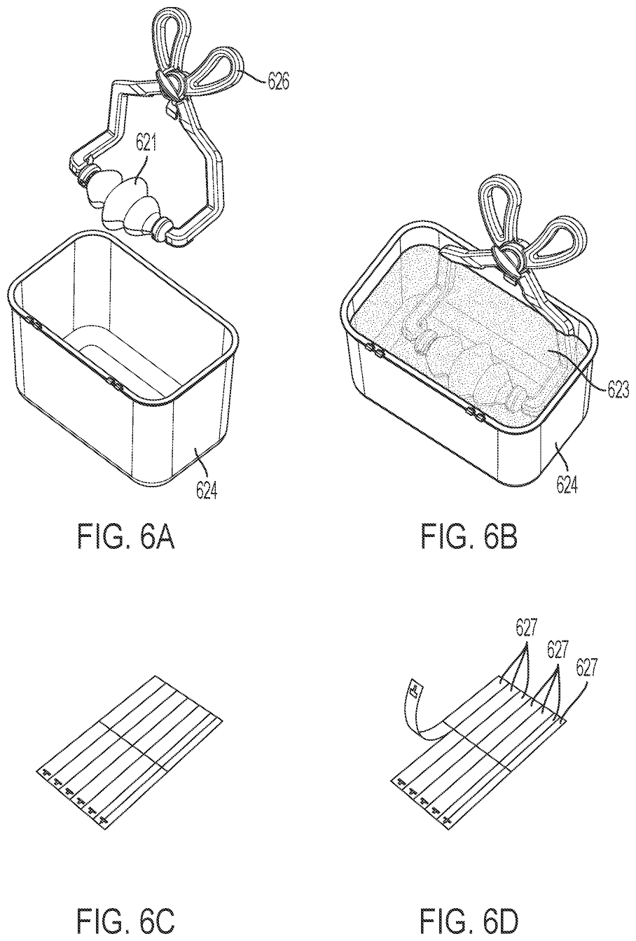

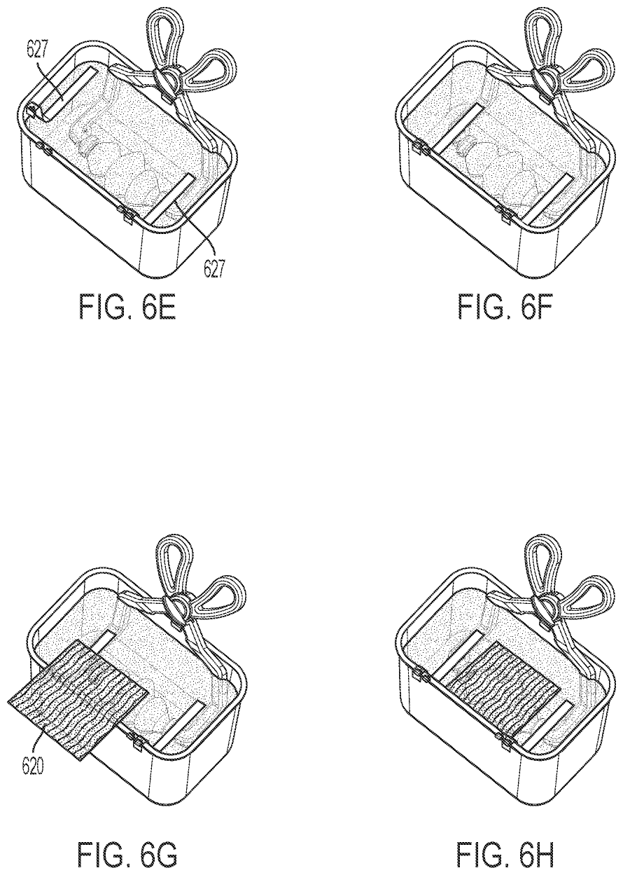

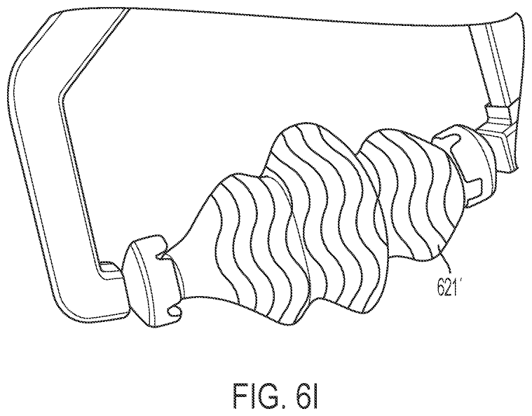

FIGS. 6A-6I show another exemplary method of using a hydrographic sheet for imparting decoration art onto a three-dimensional article, such as a figurine. FIGS. 6A and 6B show an article being picked up using a tong and placed under water in a container. FIGS. 6C and 6D show a set of stabilizer strips. The stabilizer strips may be composed of any suitable material, including, but not limited to, polyethylene terephthalate, polyethylene, polypropylene, acrylic, acrylonitrile-butadiene-styrene copolymer, polyamides, polycarbonate, polyether sulfones, polyether ether ketones, polyoxymethylene, polyphenylene oxide, polyphenylene sulphide, polyvinyl chloride, and polylactic acid, polyvinylidene fluoride, polytetrafluorethylene, polystyrene, wood, glass, or metal. FIGS. 6E and 6F shows two stabilizer strips, each having a hole on one end are being held in place, at a certain distance apart from each other, in the container by inserting the hole of each strip in posts on one of the edges of the container. In an embodiment, there are a least two sets of posts (4 total); two are closer together and are used for smaller film sheets, while the ones spaced farthest apart are for the larger film sheets.

In an embodiment, the strips have a T shaped knock out which is easily removed and when the strip is placed in the T Post it helps keep the strips perpendicular to the tub wall. FIG. 6G shows a hydrographic sheet being placed on the surface of the water between the two strips. FIG. 6H shows portions of the hydrographic sheet being expanded due to water absorption. The two strips help prevent drifting of the hydrographic sheet and holding it in space between the two strips. Once a surface of the hydrographic sheet on the surface of the water smooths out, one can lift the article out of the water, as shown in FIG. 6I, such that the article is surrounded by the hydrographic sheet, as shown in FIG. 6I, and followed by drying. Once completely dry, the article has a film with decoration art adhered onto a surface of the article.

In another aspect, a dip and decorator activity-kit includes one or more hydrographic sheets, as disclosed hereinabove, and an instruction for imparting an artistic effect to the article using the one or more hydrographic sheets. In an embodiment, the dip and decorator activity-kit comprises a means for transporting the article in and out of water. Any suitable means for transporting may be used, including, but not limited to, a basket, a tong, a tray, a cup, a spoon, or a ladle. In another embodiment, dip and decorator activity-kit comprises a pair of stabilizer strips, as disclosed herein above and shown in FIGS. 6C and 6D.

In an embodiment, the instruction for imparting an artistic effect to an article includes the following steps:
(i) immersing an article in water optionally using the means for transporting the article in and out of water;
(ii) placing at least one of the one or more hydrographic sheets on a surface of the water, whereby the water-soluble film dissolves at least partially, thereby leaving the water insoluble ink floating on the water; and
(iii) removing the article from the water through the water insoluble ink floating on the water, such that the water insoluble ink adheres to the article, thereby forming a dipped-art article.

In an embodiment, at least one of the one or more hydrographic sheets is disposed on a support substrate and the the instruction for imparting an artistic effect to an article includes a step of separating at least one of the one or more hydrographic sheets from the support substrate, before the step of placing at least one of the one or more hydrographic sheets on the surface of the water. Any suitable material can be using as a support substrate, including, but not limited comprises polyethylene terephthalate, polyethylene, polypropylene, acrylic, polyamides, polycarbonate, polyether sulfones, polyether ether ketones, polyoxymethylene, polyphenylene oxide, polyphenylene sulphide, polyvinyl chloride, and polylactic acid, polyvinylidene fluoride, polytetrafluorethylene, polystyrene, glass, or metal.

In an embodiment, at least one of the one or more hydrographic sheets is at least partially blank. In another embodiment, the dip and decorator activity-kit further comprises one or more solvent-based markers for creating an artwork on the at least partially blank hydrographic sheet.

The instruction for imparting an artistic effect to an article may further comprise placing the pair of stabilizers a distance apart from each other on the surface of the water before the step of placing at least one of the one or more hydrographic sheets on a surface of the water, wherein the hydrographic sheet is placed in between the pair of the stabilizing strips.

In an embodiment, the at least one of the one or more hydrographic sheets is fully dissolved in the water, thereby leaving the water insoluble decoration art floating on the water, and wherein the step of removing the article from the water through the water insoluble decoration art floating on the water, such that the water insoluble ink adheres to the article, thereby forming a dipped-art article.

In another embodiment, the at least one of the one or more hydrographic sheets is partially dissolved in the water, thereby leaving a softened partially solubilized water-soluble film with decoration art, floating on the water, and wherein the step of removing the article from the water through the softened partially solubilized water-soluble film with decoration art, floating on the water, such that the softened partially solubilized water-soluble film with decoration art adheres to the article, thereby forming a dipped-art article.

The one or more hydrographic sheet may have any suitable size. In an embodiment, the dip and decorator activity-kit comprises two or more hydrographic sheets, each of the same size and/or shape. In another embodiment, the dip and decorator activity-kit comprises two or more hydrographic sheets, each differing in size or shape. The hydrographic sheets can have any suitable shape, including but not limited to squares, circles, rectangles, triangles, or stars.

In another embodiment, the dip and decorator activity-kit may further comprise a container for holding water and immersing the article. The container may further comprise at least one post disposed on one edge of the container, for removably attaching at least one stabilizer strip.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination. Many other variations of the invention will be apparent to those skilled in the art and such variations are contemplated within the broad scope of the present invention.

Further aspects of the invention and preferred features thereof are given in the claims herein.

### EXAMPLES

The present invention will now be described in detail with reference to the following non-limiting examples provided to further illustrate the processes and compositions of the present invention. These examples are illustrative only and are not intended to limit the scope of the invention in any way. Unless otherwise specified all parts, percentages, and ratios are on a weight basis. The prefix C or COMP before an example indicates that it is comparative and does not form part of the invention.

Various registered trademarks, other designations and/or abbreviations are used herein to denote some of ingredients used to prepare the polymers and compositions of the invention. These are identified below by chemical name and/or trade name and optionally their manufacturer or supplier from whom they are available commercially. However, where a chemical name and/or supplier of a material described herein is not given it may easily be found for example in reference literature well known to those skilled in the art.

Unless otherwise indicated, all compositional percentages and ratios recited herein are on a weight basis and all coating weights refer to dried coating weights. The following ingredients are referred to in the Examples discussed further below.

In the examples herein when an example is described as repeated and/or prepared the same as another example described herein it is prepared analogously to the previous example using the same ingredients used in the same amounts in the same manner except where otherwise indicated.

Materials

PVOH film of thickness 76 μm was obtained from MonoSol, a division of Kuraray (Merrillville, IN). ORCO Reactive MX-series reactive dyes were obtained from Organic Dyes and Pigments, LLC (Lincoln, RI). Sodium bicarbonate was purchased from Relative Foods (Spring Lake, MI); methylcellulose was purchased from Earthborn Elements (Lakeport, MI), and hyaluronic acid was purchased from Unpretentious Skincare (Norfolk, VA).

### Example No. 1: Method of Making Casings with Color Formulations

A PVOH film having a thickness of 76 μm was cut to a desired size and shape, such as 30 mm by 30 mm. The PVOH film was folded in half and the edges were heat sealed to form a rectangular pouch with one open side, as shown in FIGS. 1A and 1B. A mixture of 1 gram powdered dye and 1 gram soda ash fixative was placed inside the compartment of the casing from the open side and the edges of the open side were heat sealed so that the powder is completely sealed, as shown in FIGS. 2A and 2B.

The color formulations included reactive dyes from the MX-Series™ from Organic Dye and Pigments combined with fixatives, specifically soda ash (sodium carbonate), mixed as dry blends. Orco Reactive MX-Series™ reactive dyes have dichlorotriazine (DCT) linking groups which promote high substantivity for cellulosics. Because of their high reactivity, a lower dyeing temperature (70-120° F. (20-50° C.)) is required to promote fixation with the fiber and therefore lend themselves to cold pad-batch, continuous, and tie-dye applications on cotton. The powder blend of dye/fixative was encased in a PVOH casing that was readily water-soluble.

It should be noted that alternatively, the sealing may be accomplished by using water as a glue for the PVOH, instead of heat sealing.

### Example No. 2: Method for Tie-Dying

A cloth article was prewashed and dried. The dried cloth article was

twisted to desired conformation and the twists and folds were secured with rubber band(s) or a string. The casings, of Example No. 1, with colorant formulations were placed on the folded article for desired colors and patterns and the casings were secured to desired position(s) by a string or rubber band(s). The cloth article with casings was placed in an 8″×10″ water-tight sealable bag. Hot water at 40-70° C. was added to the sealable bag and the bag containing the cloth article and hot water was sealed. The sealed bag was left to stand for 18 hours, and the bag was opened in a sink/tub and the excess water was removed. The cloth article was washed several times to remove excess dye and was washed with cold water and dried.

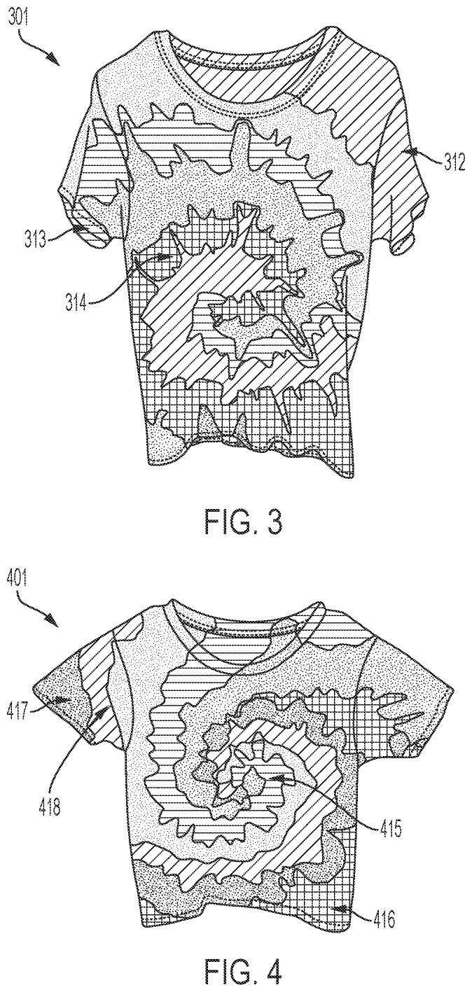

FIG. 3 shows a cloth article tie-dyed using a DIY-activity-kit, where six casings was filled with a different colorant formulation containing sodium carbonate as the fixative. The color formulations included reactive dyes from Organic Dyes and Pigments.

### Comparative Example No. 1: Conventional Tie-Dying Method

A commercially available DIY-activity-kit from Tulip Color, Fresno CA, was used to produce a tie-dyed cloth article shown in FIG. 4, without the use of casings. This was used as a control to compare the results of the conventional tie-dying with the tie dying process according to embodiments of the present invention, as exemplified in Example No. 2 above and shown in FIG. 3.

A cloth article was prewashed and dried. The dried cloth article was

twisted to desired conformation and the twists and folds were secured with rubber band(s) or a string. The dyes were applied on the folded cloth article for desired colors and patterns. The dyed cloth article was placed in an 8″×10″ water-tight sealable bag. The sealed bag was left to stand for 8 hours. The rubber bands/ties were cut off and the dyed cloth article was rinsed with water several times to remove excess dyes until the water ran clear and dried.

### Example No. 3: Method of Making a Dip Art Using a Hydrographic Sheet

FIGS. 5A-5I shows a method of using a hydrographic sheet for imparting decoration art onto an article, such as a toy plastic mouse. First, an article was placed in warm water at a temperature of 35-45° C., as shown in FIG. 5A. A hydrographic sheet was decorated using non-aqueous ink (such as alcohol-based ink, and may include a solvent dye and/or pigment) and the decorated hydrographic sheet was placed on a surface of the water, as shown in FIG. 5B. The non-aqueous ink may be any ink that is not water based, for example, any permanent marker ink such as from a Sharpie® marker or a solvent-based dry-erase marker. FIG. 5C shows that portions of the hydrographic sheet were expanded due to water absorption. Once a surface of the hydrographic sheet on the surface of the water was smoothed out, as shown in FIG. 5D, the article, such as a toy plastic mouse, was lifted out of the water, as shown in FIG. 5E, such that the article was surrounded by the hydrographic sheet, as shown in FIG. 5F. The article was dried as shown in FIGS. 5G and 5H. Once completely dry, as shown in FIG. 51, the article was found to have a film with decoration art adhered to it.

### Example No. 4: Method of Making Dye Tablets with Color Formulations

Hyaluronic acid premix comprises 3.26 grams of hyaluronic acid, 4.23 grams of glycerin, and 110.32 grams of deionized water were combined in a container. Contents were vigorously stirred to dissolve the hyaluronic acid. Preservatives Reputain B30 solution and Polyphase PW40 solution, 0.27 grams each, were added to the hyaluronic acid solution with mixing. Premix was refrigerated at 5° C. for at least four hours before using.

Encased Dye Tablet. 0.6 grams of colorant, 4.36 grams of sodium bicarbonate, 2 grams of methylcellulose, 1.5 grams of hyaluronic acid premix were combined in a suitable container and mixed thoroughly for 2 minutes. The mixture was placed in a manual Rosineer tablet press (Hillsborough, NJ). The mixture was compressed into a tablet by impacting the press with a hammer several times. The tablet was ejected and allowed to dry at room temperature overnight. The dried tablet was placed in PVOH shrink wrap and sealed using hot air.

TABLE 1

| | | RED TABLET | | YELLOW TABLET | | BLUE TABLET | |
|---|---|---|---|---|---|---|---|
| INGREDIENT | Function | grams | % | grams | % | grams | % |
| Sodium | Fixative | 4.36 | 51.54 | 4.36 | 51.54 | 4.36 | 51.54 |
| Bicarbonate | | | | | | | |
| Methylcellulose | Filler | 2 | 23.64 | 2 | 23.64 | 2 | 23.64 |
| Hyaluronic Acid | Binder | 1.5 | 17.73 | 1.5 | 17.73 | 1.5 | 17.73 |
| Premix | | | | | | | |
| ORCO Reactive | Colorant | 0.6 | 7.09 | 0 | 0 | 0 | 0 |
| Red MX-5B | | | | | | | |
| ORCO Reactive | Colorant | 0 | 0.00 | 0.6 | 7.09 | 0 | 0.00 |
| Yellow MX-8G | | | | | | | |
| ORCO Reactive | Colorant | 0 | 0.00 | 0 | 0 | 0.6 | 7.09 |
| Blue MX-R | | | | | | | |
| TOTAL | | 8.46 | 100 | 8.46 | 100 | 8.46 | 100.00 |

TABLE 2
Composition of Hyaluronic Acid
Premix of Table 1

| INGREDIENT | g | wt % |
|---|---|---|
| Hyaluronic acid powder | 3.26 | 2.75 |
| Glycerin | 4.23 | 3.57 |
| Water | 110.32 | 93.22 |
| Reputain B30 preservative | 0.27 | 0.23 |
| Polyphase PW40 preservative | 0.27 | 0.23 |
| Total | 118.35 | 100 |

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A casing comprising:
a) at least one compartment formed of a water-soluble film, and
b) one or more agents disposed within the at least one compartment, wherein the one or more agents are configured to impart an artistic effect to an article.

2. The casing according to claim 1, wherein the one or more agents comprise one or more of a colorant formulation, a fixative, a water insoluble ink formulation, a multi-part leuco dye system, a multi-part effervescent composition, a multi-part silicone system, a multi-part chemiluminescent system, a glitter, and a fragrance.

3. The casing according to claim 1, wherein the casing comprises a single compartment formed of the water-soluble film, wherein the one or more agents comprises at least one colorant formulation and at least one fixative, disposed as a mixture in the compartment.

4. The casing according to claim 1, wherein the casing comprises two or more compartments formed of the water-soluble film isolated from each other, and wherein the one or more agents comprises at least one colorant formulation and at least one fixative, wherein the colorant formulation and the fixative are disposed in separate compartments.

5. The casing according to claim 1, wherein the water-soluble film comprises one or more of poly(ethylene glycol) (PEG), polyvinyl pyrrolidone (PVP), polyvinyl alcohol (PVOH), polyvinyl acetate (PVA), polyacrylic acid (PAA), polyacrylamides, N-(2-hydroxypropyl) methacrylamide (HPMA), divinyl ether-maleic anhydride (DIVEMA), polyoxazoline, polyphosphates, and polyphosphazenes.

6. The casing according to claim 1, wherein the water-soluble film comprises one or more of natural polymer films selected from the group consisting of xanthan gum, pectins, chitosan derivatives, dextran, carrageenan, guar gum, cellulose ethers, hyaluronic acid, albumin, and starch or starch-based derivatives.

7. The casing according to claim 2, wherein the colorant formulation comprises an acidic dye, a basic dye, a direct dye, a reactive dye, a sulfur dye, a fluorescent dye, a solvent dye, a food dye (FD&C), a cosmetic dye (D&C), a fabric dye, a polymeric dye, a fluorescent dye, a leuco dye, a photochromic dye, or a thermochromic dye.

8. The casing according to claim 2, wherein the colorant formulation comprises a water-soluble dye selected from the group consisting of an acidic dye, a basic dye, a direct dye, a food dye (FD&C), a cosmetic dye (D&C), and a reactive dye.

9. The casing according to claim 1, wherein the one or more agents comprises an oxime silicone.

10. The casing according to claim 1, wherein the casing comprises at least two compartments, wherein the one or more agents comprises a multi-part formulation, and wherein each part of the multi-part formulation is disposed in a separate compartment of the at least two compartments.

11. The casing according to claim 10, wherein the multi-part formulation comprises the multi-part leuco dye system, the multi-part silicone system, the multi-part chemiluminescent system, or the multi-part effervescent composition.

12. The casing according to claim 1, wherein the casing and each of the one or more compartments has a shape of a sphere, a hemisphere, a cylinder, a cube, a cuboid, an ellipsoid, a polyhedron, a star, a heart, or a toroid.

13. The casing according to claim 2, wherein the casing is a compressible pouch, which when compressed ruptures the casing to release colorant formulation for creating an art form.

14. The casing according to claim 1, wherein the water-soluble film has a thickness in the range of 10-150 μm.

15. The casing according to claim 1, wherein the casing is an encased tablet, wherein at least one or more agents disposed within the at least one compartment is in a form of a dye tablet comprising one or more agents compounded with a binder and an optional filler, wherein the at least one or more agents comprise at least one colorant formulation and at least one fixative and wherein the one or more agents are configured to impart an artistic effect to an article.

16. The encased dye tablet according to claim 15, wherein the optional filler comprises a clay, a starch, a polymeric resin, a cellulose compound, or a saccharide.

17. The encased dye tablet according to claim 15 wherein binder comprises hyaluronic acid powder, gelatin, gums, algininc acids and salts, and polymers.

18. The encased dye tablet according to claim 15, wherein the colorant formulation comprises an acidic dye, a basic dye, a direct dye, a reactive dye, a sulfur dye, a fluorescent dye, a solvent dye, a food dye (FD&C), a cosmetic dye (D&C), a fabric dye, a polymeric dye, a fluorescent dye, a leuco dye, a photochromic dye, or a thermochromic dye.

19. The encased dye tablet according to claim 15, wherein the colorant formulation comprises a water-soluble dye selected from the group consisting of an acidic dye, a basic dye, a direct dye, a food dye (FD&C), a cosmetic dye (D&C), and a reactive dye.

20. The encased dye tablet according to claim 16, wherein the one or more agents further comprises a humectant, a preservative, a multi-part effervescent composition, a multi-part silicone system, a multi-part chemiluminescent system, a glitter, or a fragrance.

21. A DIY activity-kit comprising:
one or more casings according to claim 1, one or more encased dye tablets, or a combination thereof; and
instructions to form at least one of a decoration art, a tie-dye art, a glitter art, or a squeezable art,
wherein the encased dye tablet comprises one or more agents compounded with a filler and a binder, wherein one or more agents comprise at least one colorant formulation and at least one fixative and wherein the one or more agents are configured to impart an artistic effect to an article.

22. The DIY activity-kit of claim 21, wherein at least one of the one or more casings and one or more encased dye tablets comprises a colorant formulation and wherein the instructions to form a tie-dye art comprise the steps of:
a) contacting one or more casings, one or more dye tablets, or a combination thereof with a cloth article;
b) twisting and/or folding the cloth article about the one or more casings, one or more dye tablets, or a combination thereof;
c) binding the twists and folds of the cloth article to form a bound cloth article; and
d) contacting the bound cloth article with water to form a dyed cloth article.

23. The DIY activity-kit of claim 21, wherein at least one of the one or more casings comprises one or more agents disposed within the at least one compartment of the one or more casings in a powdered form.

24. The DIY activity-kit of claim 21, wherein at least one of the one or more casings comprises one or more agents disposed within the at least one compartment of the one or more casings in a form of the dye-tablet.

25. The DIY activity-kit of claim 22, wherein the step of binding the twists and folds of the cloth article comprises securing the twists and folds of the cloth article using rubber bands or ties.

26. The DIY activity-kit of claim 22, wherein the instructions further comprise the step of removing the binding from the bound cloth article.
